(19) United States
(12) Patent Application Publication
(10) Pub. No.: US 2025/0193833 A1
(43) Pub. Date: Jun. 12, 2025

(54) DATA COLLECTION METHOD AND APPARATUS

(71) Applicant: VIVO MOBILE COMMUNICATION CO., LTD., Dongguan (CN)

(72) Inventors: Chenglu JIA, Dongguan (CN); Ang YANG, Dongguan (CN); Peng SUN, Dongguan (CN)

(73) Assignee: VIVO MOBILE COMMUNICATION CO., LTD., Dongguan (CN)

(21) Appl. No.: 19/010,159

(22) Filed: Jan. 5, 2025

Related U.S. Application Data
(63) Continuation of application No. PCT/CN2023/105820, filed on Jul. 5, 2023.

(30) Foreign Application Priority Data
Jul. 8, 2022 (CN) 202210834728.9

(51) Int. Cl. H04W 64/00; H04L 5/00

(52) U.S. Cl. CPC H04W 64/00; H04L 5/0048

(57) ABSTRACT

A data collection method and a terminal are provided. The data collection method includes: receiving first information by the terminal. The first information includes first indication information or second indication information. The first indication information indicates the terminal to collect channel state data used for positioning. The second indication information indicates the terminal to send an uplink reference signal. The data collection method further includes that when the first information includes the first indication information, determining that the channel state data used for positioning needs to be collected. The data collection method also includes sending the uplink reference signal when the first information includes the second indication information. The uplink reference signal is used by a network side device to collect the channel state data used for positioning.

### CROSS-REFERENCE TO RELATED APPLICATIONS

This application is a continuation of International Application No. PCT/CN2023/105820, filed on Jul. 5, 2023, which claims priority to Chinese Patent Application No. 202210834728.9, filed on Jul. 8, 2022. The entire contents of each of the above-referenced applications are expressly incorporated herein by reference.

### TECHNICAL FIELD

This application relates to the field of communication technologies, and in particular, to a data collection method and apparatus.

### BACKGROUND

In a positioning enhancement case that is based on Artificial Intelligence (AI), accuracy of an AI model greatly depends on a scale and quality of a data set.

However, large-scale and high-quality data collection consumes excessive resources, and the collection is not easy to implement. As a result, a training sample size is small, and positioning accuracy of a trained AI model is low.

### SUMMARY

Embodiments of this application provide a data collection method and apparatus.

According to a first aspect, a data collection method is provided, and the method includes:
A terminal receives first information, where the first information includes first indication information and/or second indication information, the first indication information indicates the terminal to collect channel state data used for positioning, and the second indication information indicates the terminal to send an uplink reference signal;
in a case that the first information includes the first indication information, the terminal determines that the channel state data used for positioning needs to be collected; and
the terminal sends the uplink reference signal in a case that the first information includes the second indication information, where the uplink reference signal is used by a network side device to collect the channel state data used for positioning.

The channel state data used for positioning includes channel state data carrying a location label and channel state data not carrying a location label.

According to a second aspect, a data collection method is provided, and the method includes:
A network side device sends first information to a terminal.

The first information includes first indication information and/or second indication information, the first indication information indicates the terminal to collect channel state data used for positioning, the second indication information indicates the terminal to send an uplink reference signal, and the uplink reference signal is used by the network side device to collect the channel state data used for positioning.

The channel state data used for positioning includes channel state data carrying a location label and channel state data not carrying a location label.

According to a third aspect, a data collection apparatus is provided, and the apparatus includes:
a first receiving module, configured to receive first information, where the first information includes first indication information and/or second indication information, the first indication information indicates the terminal to collect channel state data used for positioning, and the second indication information indicates the terminal to send an uplink reference signal;
a first determining module, configured to: in a case that the first information includes the first indication information, determine that the channel state data used for positioning needs to be collected; and
a first sending module, configured to send the uplink reference signal in a case that the first information includes the second indication information, where the uplink reference signal is used by a network side device to collect the channel state data used for positioning.

The channel state data used for positioning includes channel state data carrying a location label and channel state data not carrying a location label.

According to a fourth aspect, a data collection apparatus is provided, and the apparatus includes:
a second sending module, configured to send first information to a terminal.

The first information includes first indication information and/or second indication information, the first indication information indicates the terminal to collect channel state data used for positioning, the second indication information indicates the terminal to send an uplink reference signal, and the uplink reference signal is used by the network side device to collect the channel state data used for positioning.

The channel state data used for positioning includes channel state data carrying a location label and channel state data not carrying a location label.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The communication interface is configured to:
receive first information, where the first information includes first indication information and/or second indication information, the first indication information indicates the terminal to collect channel state data used for positioning, and the second indication information indicates the terminal to send an uplink reference signal;
the processor is configured to:
in a case that the first information includes the first indication information, determine that the channel state data used for positioning needs to be collected; and
the communication interface is configured to:
send the uplink reference signal in a case that the first information includes the second indication information, where the uplink reference signal is used by a network side device to collect the channel state data used for positioning.

The channel state data used for positioning includes channel state data carrying a location label and channel state data not carrying a location label.

According to a seventh aspect, a network side device is provided. The network side device includes a processor and a memory, the memory stores a program or an instruction that can be run on the processor, and the program or the instruction is executed by the processor to implement the steps of the method according to the second aspect.

According to an eighth aspect, a network side device is provided, including a processor and a communication interface, where the communication interface is configured to: send first information to a terminal.

The first information includes first indication information and/or second indication information, the first indication information indicates the terminal to collect channel state data used for positioning, the second indication information indicates the terminal to send an uplink reference signal, and the uplink reference signal is used by the network side device to collect the channel state data used for positioning.

The channel state data used for positioning includes channel state data carrying a location label and channel state data not carrying a location label.

According to a ninth aspect, a data collection system is provided, including: a terminal and a network side device, where the terminal may be configured to perform the steps of the data collection method according to the first aspect, and the network side device may be configured to perform the steps of the data collection method according to the second aspect.

According to a tenth aspect, a readable storage medium is provided, where the readable storage medium stores a program or an instruction, and when the program or the instruction is executed by a processor, the steps of the method according to the first aspect or the steps of the method according to the second aspect are implemented.

According to an eleventh aspect, a chip is provided, where the chip includes a processor and a communication interface, the communication interface is coupled to the processor, and the processor is configured to run a program or an instruction, to implement the steps of the method according to the first aspect or the steps of the method according to the second aspect.

According to a twelfth aspect, a computer program/program product is provided, where the computer program/program product is stored in a storage medium, and the computer program/program product is executed by at least one processor to implement the steps of the method according to the first aspect or the steps of the method according to the second aspect.

In this embodiment of this application, the terminal collects, based on the indication, the channel state data used for positioning, and/or sends the uplink reference signal, so that the network side device collects the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

### BRIEF DESCRIPTION OF THE DRAWINGS

FIG. 1 is a block diagram of a wireless communication system to which the embodiments of this application can be applied;

FIG. 2 is a schematic diagram of a neural network according to an embodiment of this application;

FIG. 3 is a schematic diagram of a neuron according to an embodiment of this application;

FIG. 4 is a first schematic flowchart of a data collection method according to an embodiment of this application;

FIG. 5 is a second schematic flowchart of a data collection method according to an embodiment of this application;

FIG. 6 is a schematic diagram of an application of data collection according to an embodiment of this application;

FIG. 7 is a schematic diagram of a structure of a first model according to an embodiment of this application;

FIG. 8 is a schematic diagram of positioning precision according to an embodiment of this application;

FIG. 9 is a first schematic diagram of a structure of a data collection apparatus according to an embodiment of this application;

FIG. 10 is a second schematic diagram of a structure of a data collection apparatus according to an embodiment of this application;

FIG. 11 is a schematic diagram of a structure of a communication device according to an embodiment of this application;

FIG. 12 is a schematic diagram of a hardware structure of a terminal according to an embodiment of this application; and

FIG. 13 is a schematic diagram of a hardware structure of a network side device according to an embodiment of this application.

### DETAILED DESCRIPTION

The following clearly describes technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in the specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application may be used interchangeably. The described technologies can be applied to both the systems and the radio technologies mentioned above as well as to other systems and radio technologies. The following descriptions describe a New Radio (NR) system for example purposes, and NR terms are used in most of the following descriptions, but these technologies can also be applied to an application other than an NR system application, for example, a 6^{th} Generation (6G) communication system.

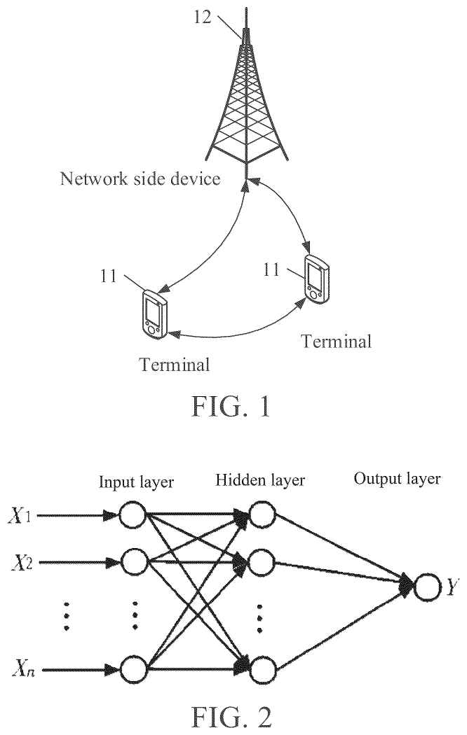

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart household (household devices with wireless communication functions, such as a refrigerator, a television, a washing machine, or furniture), a game console, a Personal Computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that, a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access node, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), and an Application Function (AF). It should be noted that, in the embodiments of this application, the core network device in the NR system is merely used as an example for description, but a specific type of the core network device is not limited.

First, the following content is described.

Currently, AI is widely used in various fields, and it is an important task for the future wireless communication network to integrate artificial intelligence into the wireless communication network and significantly improve technical indicators such as throughput, delay, and user capacity. An AI module has various implementations, such as a neural network, a decision tree, a support vector machine, or a Bayes classifier. In this application, the neural network is used as an example for description, but a specific type of the AI module is not limited.

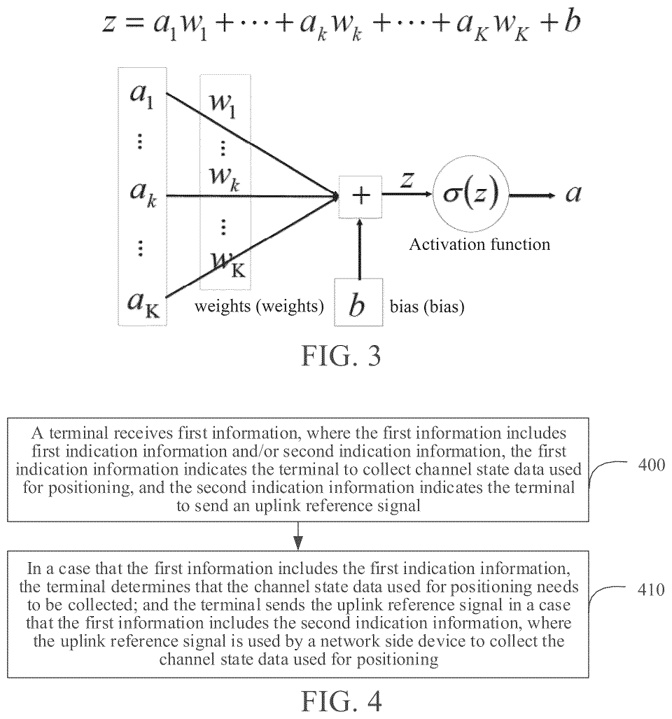

FIG. 2 is a schematic diagram of a neural network according to an embodiment of this application, and FIG. 3 is a schematic diagram of a neuron according to an embodiment of this application. As shown in FIG. 2 and FIG. 3, the neural network includes neurons, where a1, a2, . . . , aK are inputs, w is a weighted value (multiplicative coefficient), b is an offset (additive coefficient), and σ(.) is an activation function. Common activation functions include Sigmoid, tanh, ReLU (Rectified Linear Unit, linear rectification function, modified linear unit), or the like.

Parameters of the neural network are optimized by using a gradient optimization algorithm. The gradient optimization algorithm is a type of algorithm that minimizes or maximizes an objective function (sometimes referred to as a loss function), and the objective function is usually a mathematical combination of a model parameter and data. For example, given data X and a corresponding label Y may construct a neural network model f (.). After the model is constructed, a predicted output f(x) can be obtained based on the input x, and a difference (f(x)−Y) between a predicted value and a real value can be calculated. This is the loss function. Appropriate W and b may be found, so that a value of the loss function reaches a minimum. A smaller loss value indicates that the model is closer to a real situation.

Currently, common optimization algorithms are basically based on an error Back Propagation (BP) algorithm. A basic idea of the BP algorithm is that a learning process includes two processes: signal forward propagation and error back propagation. During forward propagation, an input sample is transferred from an input layer to an output layer after being processed by each hidden layer. If an actual output of the output layer does not match an expected output, error back propagation is performed. Error back propagation is to transmit an output error layer by layer to the input layer through a hidden layer in some form for back propagation, and allocate the error to all units of each layer, to obtain an error signal of a unit at each layer. This error signal is used as a basis for correcting a weighted value of each unit. A weighted value adjustment process of each layer during signal forward propagation and error back propagation is carried out repeatedly. A process of continuously adjusting a weighted value is a learning and training process of a network. This process continues until errors output by the network are reduced to an acceptable level or until a preset quantity of learning times are reached.

Common optimization algorithms include gradient descent, Stochastic Gradient Descent (SGD), mini-batch gradient descent, Momentum, Nesterov (the name of the inventor, which is a stochastic gradient descent of a driving amount), ADAptive GRADient descent (Adagrad), Adadelta, Root Mean Square prop (RMSprop), Adaptive Moment Estimation (Adam), or the like.

During error back propagation, in these optimization algorithms, an error/loss is obtained according to the loss function, a gradient is obtained by calculating a derivative/partial derivative of a current neuron, and adding an effect such as a learning rate and a previous gradient/derivative/partial derivative, and the gradient is transferred to an upper layer.

The data collection method and apparatus provided in the embodiments of this application are described in detail below with reference to the accompanying drawings by using some embodiments and application scenarios thereof.

FIG. 4 is a first schematic flowchart of a data collection method according to an embodiment of this application. As shown in FIG. 4, the method includes the following steps.

Step 400: A terminal receives first information, where the first information includes first indication information and/or second indication information, the first indication information indicates the terminal to collect channel state data used for positioning, and the second indication information indicates the terminal to send an uplink reference signal.

Step 410: In a case that the first information includes the first indication information, the terminal determines that the channel state data used for positioning needs to be collected; and the terminal sends the uplink reference signal in a case that the first information includes the second indication information, where the uplink reference signal is used by a network side device to collect the channel state data used for positioning.

In some embodiments, high-dimensional channel state data may be mapped to a low-dimensional manifold space (for example, two-dimensional) having the same location dimension. It may be considered that the mapping implements a principle of proximity reservation. For example, similar locations in an actual space have similar pieces of channel state data, and the similar pieces of channel state data have similar mapping in the low-dimensional manifold space. A subsequent location-based service may be replaced with a location in a manifold space.

Therefore, during training of an AI model for positioning, the channel state data may be used as a training sample.

In some embodiments, the AI technology can significantly improve positioning precision. In the wireless communication network, an input for the AI model may be channel state data from a to-be-positioned device such as a plurality of TRPs, for example, a channel impulse response, and an output of the AI model is location prediction information of the AI model for the to-be-positioned device, for example, a location prediction result or an intermediate feature quantity. The intermediate feature quantity may assist in location calculation. However, AI-based positioning precision enhancement requires a large amount of available training data with real labels, that is, channel state data samples with location labels. Collection of these data samples needs a large amount of resources. Relatively, a channel state data sample without a location label is easier to be obtained. For example, only channel state data of a user may be collected without collecting a location label.

In some embodiments, semi-supervised learning is a method for training an AI model by using some channel state data samples with location labels and some channel state data samples without a location label.

In some embodiments, the channel state data used for positioning includes channel state data carrying a location label and channel state data not carrying a location label.

In this embodiment of this application, the collected channel state data used for positioning may include data based on a small quantity of channel state data samples with location labels and a large quantity of channel state data samples without a location label, and is used for semi-supervised learning of the AI model.

In some embodiments, the terminal may receive the first indication information sent by the network side device, and determine, based on the first indication information, that the channel state data used for positioning needs to be collected, to collect, on a terminal side, the channel state data used for positioning.

In some embodiments, the terminal may receive the second indication information sent by the network side device, and send the uplink reference signal based on the second indication information, so that the network side device may collect the channel state data used for positioning based on the received uplink reference signal, to collect, on a network side, the channel state data used for positioning.

In some embodiments, the terminal may receive the first indication information and the second indication information sent by the network side device, determine, based on the first indication information, that the channel state data used for positioning needs to be collected on the terminal side, and send the uplink reference signal based on the second indication information, so that the network side device may collect the channel state data used for positioning based on the received uplink reference signal, and may collect the channel state data used for positioning on both sides of communication.

In an embodiment, the network side device may indicate the terminal to collect positioning data, that is, the network side device sends the first indication information to the terminal, where the first indication information requires the terminal to collect channel state data carrying a location label and channel state data not carrying a location label.

In an embodiment, the network side device may collect positioning data in collaboration with the terminal side. The network side device may collect channel state data not carrying a location label, and the terminal side may collect channel state data carrying a location label. For example, the network side device sends the first indication information and the second indication information to the terminal, requires, by using the first indication information, the terminal to collect the channel state data carrying a location label, and indicates, by using the second indication information, the terminal to send the uplink reference signal.

In an embodiment, the network side device may collect positioning data, including channel state data carrying a location label and channel state data not carrying a location label. The network side device may send the second indication information to the terminal, to indicate the terminal to send the uplink reference signal, and the network side device may collect the channel state data carrying a location label and the channel state data not carrying a location label based on the uplink reference signal.

In some embodiments, a manner in which the network side device obtains the location label may include: a location of the terminal is known in advance on a network side, and location information is obtained by using another positioning method, for example, a global positioning system. Conventional positioning methods include Observed Time Difference of Arrival (OTDOA) positioning, cell Identifier (Cell ID) positioning, barometric pressure sensor positioning, Wireless Local Area Network (WLAN) positioning, Terrestrial Beacon System (TBS) positioning, motion sensor positioning, Multi-Round-Trip Time (Multi-RTT) positioning, Downlink Angle-of-Departure (DL-AOD) positioning, Downlink Time Difference Of Arrival (DL-TDOA) positioning, Uplink Time Difference Of Arrival (UL-TDOA) positioning, Uplink Angles of Arrival (UL-AOA) positioning, and the like.

In this embodiment of this application, the terminal collects, based on the indication, the channel state data used for positioning, and/or sends the uplink reference signal, so that the network side device collects the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

In some embodiments, the first indication information includes at least one of following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection;
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

In some embodiments, the first indication information includes any one or more of the following:
a type identifier ID of data collection, for example, data that is indicated to be collected by using the first indication information is a time domain channel impulse response; or
a target task of data collection, for example, data that is indicated to be collected by using the first indication information is used for AI positioning; or
a time interval of data collection, for example, data collection is performed every A time units, where A is a positive integer; or
a space interval of data collection, for example, the terminal performs data collection once every time the terminal moves by B distance units, for example, performs sampling D times within C distance units, for example, performs sampling P times within F-E distance units, where B, C, D, E, F, and P are all positive integers; or
an amount of data collection, for example, T pieces of data are collected, for example, Y groups of data are collected, where T is a positive integer, and Y is a positive integer; or
a start time of data collection; or
an end time of data collection; or
duration of data collection; or
data accuracy of data collection, that is, precision of data expected to be collected; or
a data accuracy requirement reported after the data collection; or
format information reported after the data collection, for example, indicates that the collected data needs to be grouped, for example, data at times N1, N2, and N3 is grouped into one group (N1, N2, N3), where N1, N2, and N3 are all positive integers; or
a data compression indication reported after the data collection may indicate whether the data collected by the terminal is compressed first and then reported, for example, one bit, where when the bit is 1, it indicates that the data collected by the terminal needs to be compressed and then reported, and when the bit is 0, it indicates that the data collected by the terminal is directly reported without compression; or
downlink reference signal information for data collection may include: port information, time domain information, frequency domain information, or space domain information; or
a carrying indication of the location label may indicate whether the data collected by the terminal carries the location label, for example, one bit, where when the bit is 1, it indicates that the data collected by the terminal needs to carry the location label, and when the bit is 0, it indicates that the data collected by the terminal does not need to carry the location label; or
a carrying indication of timestamp information may indicate whether the data collected by the terminal carries the timestamp information, for example, one bit, where when the bit is 1, it indicates that the data collected by the terminal needs to carry the timestamp information, and when the bit is 0, it indicates that the data collected by the terminal does not need to carry the timestamp information; or
a carrying indication of channel estimation error information may indicate whether the data collected by the terminal carries the channel estimation error information, for example, one bit, where when the bit is 1, it indicates that the data collected by the terminal needs to carry the channel estimation error information, and when the bit is 0, it indicates that the data collected by the terminal does not need to carry the channel estimation error information; or
a carrying indication of location labeling error information may indicate whether the data collected by the terminal carries the location labeling error information, for example, one bit, where when the bit is 1, it indicates that the data collected by the terminal needs to carry the location labeling error information, and when the bit is 0, it indicates that the data collected by the terminal does not need to carry the location labeling error information; or
a carrying indication of reference signal measurement quality information may indicate whether the data collected by the terminal carries the reference signal measurement quality information, for example, one bit, where when the bit is 1, it indicates that the data collected by the terminal needs to carry the reference signal measurement quality information, and when the bit is 0, it indicates that the data collected by the terminal does not need to carry the reference signal measurement quality information; or
a carrying indication of motion state information of the terminal may indicate whether the data collected by the terminal carries corresponding motion state information, for example, one bit, where when the bit is 1, it indicates that the data collected by the terminal needs to carry the corresponding motion state information, and when the bit is 0, it indicates that the data collected by the terminal does not need to carry the corresponding motion state information, where the motion state information may include a motion speed, a motion acceleration, and the like; or
a data compression format, for example, indicates a data compression format in which the data collected by the terminal is compressed.

In some embodiments, one time unit may be one OFDM symbol, one slot, one subframe, one frame, one reference signal sending period, one microsecond, one millisecond, one second, one minute, one hour, or the like, and this is not limited in this embodiment of this application.

In some embodiments, one distance unit may be one centimeter, one decimeter, one meter, one kilometer, or the like, and this is not limited in this embodiment of this application.

In some embodiments, the second indication information includes resource information for transmitting the uplink reference signal, and the resource information includes at least one of the following:
port information, time domain information, frequency domain information, or space domain information.

In some embodiments, after receiving the second indication information, the terminal may transmit the uplink reference signal based on the resource information of the uplink reference signal.

In some embodiments, in a case that the first information includes the first indication information, the method further includes:
The terminal sends the channel state data used for positioning to the network side device in a case of having a first capability, where the first capability is a capability of providing the network side device with data conforming to the first indication information.

In some embodiments, after receiving the first indication information, the terminal may determine, based on device capability information of the terminal, whether a collection requirement and/or a reporting requirement proposed by the network side device by using the first indication information can be supported.

In some embodiments, if the terminal determines that the collection requirement and the reporting requirement proposed by the network side device by using the first indication information can be supported, the terminal may collect, based on a collection requirement in the first indication information, the channel state data used for positioning, and report, based on a reporting requirement in the first indication information, the channel state data used for positioning.

In some embodiments, if the terminal determines that the collection requirement proposed by the network side device by using the first indication information can be supported, but the reporting requirement is not supported, the terminal may collect the channel state data used for positioning based on the collection requirement in the first indication information, and report the channel state data used for positioning as much as possible based on the reporting requirement in the first indication information. For an aspect that does not meet the reporting requirement, the terminal reports the channel state data used for positioning based on a device capability of the terminal.

In some embodiments, if the terminal determines that the collection requirement proposed by the network side device by using the first indication information cannot be supported, the terminal may not perform collection and reporting operations.

In some embodiments, the channel state data sent by the terminal to the network side device includes at least one of the following:
data that meets the first indication information;
a location label of the data;
channel estimation error information corresponding to the data;
location labeling error information corresponding to the data;
reference signal measurement quality information corresponding to the data;
motion state information of the terminal;
timestamp information of data collection;
third indication information or fourth indication information, where the third indication information represents that the data carries the location label, and the fourth indication information represents that the data does not carry the location label;

fifth indication information, where the fifth indication information represents that data compression has been performed on the data; and
a format of the data compression.

In some embodiments, the location labeling error information corresponding to the data may include a confidence and/or deviation range of the location label carried in the data. For example, a location error may be 3 meters or 1 meter.

In some embodiments, the location labeling error information corresponding to the data may include error indication information of the location label carried in the data, and may be one-bit information. For example, if an error is greater than a preset error threshold of the location label, an identifier 1 is reported for the bit, or otherwise, 0 is reported.

In some embodiments, the channel estimation error information corresponding to the data may include a confidence and/or deviation range of channel estimation carried in the data.

In some embodiments, the channel estimation error information corresponding to the data may include error indication information of the channel estimation carried in the data, and may be one-bit information. For example, if an error is greater than a preset error threshold of the channel estimation, an identifier 1 is reported for the bit, or otherwise, 0 is reported.

In some embodiments, the method further includes:
The terminal sends first feedback information to the network side device, where the first feedback information represents that the terminal has the first capability.

In some embodiments, if the terminal determines that the collection and reporting requirement proposed by the network side device by using the first indication information can be supported, the terminal may send the first feedback information to the network side device, to represent that the terminal supports the collection and reporting requirement proposed by the network side device by using the first indication information, and is about to report the collected channel state data used for positioning. In this way, the network side device may receive, on a corresponding resource, the channel state data reported by the terminal for positioning.

In some embodiments, if the terminal determines that the collection requirement and a part of the reporting requirement proposed by the network side device by using the first indication information can be supported, the terminal may send the first feedback information to the network side device, and may further carry an indication of the supported part of the reporting requirement in the first feedback information, to represent that the terminal supports the collection requirement and the part of the reporting requirement proposed by the network side device by using the first indication information, and is about to report the collected channel state data used for positioning. In this way, the network side device may receive, on a corresponding resource, the channel state data reported by the terminal for positioning.

In some embodiments, that the terminal sends the channel state data used for positioning to the network side device includes at least one of the following:
the terminal sends the channel state data to the network side device based on a time period, where the time period is determined based on an indication of the network side device, predefined based on a protocol, or preset;
the terminal sends the channel state data to the network side device based on a collection period, where each collection period corresponds to a second amount of channel state data, and the second amount is determined based on an indication of the network side device, predefined based on a protocol, or preset;
the terminal sends, based on a transmission resource allocated by the network side device for the channel state data used for positioning, a first amount of channel state data to the network side device, where the first amount is a maximum value at which a size of the transmission resource supports transmission of the channel state data;
after duration of collection reaches a target collection time, the terminal sends, to the network side device, channel state data collected within the duration; or
after an amount of collected channel state data reaches a target amount, the terminal sends, to the network side device, the target amount of channel state data.

In some embodiments, that the terminal sends the channel state data to the network side device based on a time period may be that the terminal reports the channel state data once every time the terminal collects for a first period, for example, the terminal reports channel state data that is collected in the current one minute and that is used for positioning once every time the terminal collects for 1 minute.

In some embodiments, the network side may allocate the transmission resource for the channel state data used for positioning, and the terminal may determine a maximum amount (that is, the first amount) of channel state data that can be transmitted on the transmission resource, and then collect and report the first amount of channel state data.

In some embodiments, that the terminal sends the channel state data to the network side device based on a collection period may be that every time the terminal collects P pieces or P groups of data, the terminal reports the P pieces or the P groups of data once.

In some embodiments, the terminal may report, after the duration of collection reaches the target collection time, channel state data that is collected within the duration and that is used for positioning to the network side.

In some embodiments, the terminal may report the target amount of channel state data used for positioning to the network side after the amount of collected channel state data reaches the target amount.

In some embodiments, that the terminal sends the channel state data used for positioning to the network side device includes:
The terminal sends the channel state data used for positioning to the network side device in a first transmission resource, where the first transmission resource is determined based on an indication of the network side device.

The first transmission resource includes at least one of the following:
a time domain resource, a space domain resource, a frequency domain resource, or a port resource.

In some embodiments, the network side device may configure the first transmission resource for the terminal in advance before the terminal sends the channel state data used for positioning to the network side device, and the terminal may send the channel state data used for positioning to the network side device in the first transmission resource.

In some embodiments, that the terminal sends the channel state data used for positioning to the network side device includes:
The terminal sends channel state data that meets a first condition to the network side device.

The channel state data that meets the first condition includes at least one of the following:
confidence of the location label of the channel state data is within a confidence range;
a deviation range of the location label of the channel state data is less than a deviation threshold; and
the channel state data is collected under a first channel condition.

The first channel condition includes at least one of the following:
a Reference Signal Receiving Power (RSRP) is greater than a first RSRP threshold;
the RSRP is greater than or equal to a second RSRP threshold;
a Signal-Noise Ratio (SNR) is greater than a first SNR threshold;
the SNR is greater than or equal to a second SNR threshold;
a Signal to Interference plus Noise Ratio (SINR) is greater than a first SINR threshold;
the SINR is greater than or equal to a second SINR threshold;
an interference is less than a first interference threshold; and
the interference is less than or equal to a second interference threshold.

In some embodiments, the first RSRP threshold may be preset, predefined in a protocol, or determined based on an indication of a higher layer or a network side.

In some embodiments, the second RSRP threshold may be preset, predefined in a protocol, or determined based on an indication of a higher layer or a network side.

In some embodiments, the second SNR threshold may be preset, predefined in a protocol, or determined based on an indication of a higher layer or a network side.

In some embodiments, the first SNR threshold may be preset, predefined in a protocol, or determined based on an indication of a higher layer or a network side.

In some embodiments, after collecting the channel state data used for positioning, the terminal may send all data that meets a requirement of the first indication information to the network side device.

In some embodiments, after collecting the channel state data used for positioning, the terminal may send only a part of all the data that meets the requirement of the first indication information to the network side device, to ensure high quality of data samples.

In some embodiments, it is possible to send, to the network side device, only channel state data that is used for positioning and that carries a location label with confidence being within the confidence range.

In some embodiments, it is possible to send, to the network side device, only channel state data that is used for positioning and that carries a deviation range less than the deviation threshold.

In some embodiments, it is possible to send, to the network side device, only channel state data collected under the first channel condition.

For example, it is possible to send, to the network side device, only channel state data collected in a case that the reference signal received power RSRP is greater than the first RSRP threshold.

For example, it is possible to send, to the network side device, only channel state data collected in a case that the RSRP is greater than or equal to the second RSRP threshold.

For example, it is possible to send, to the network side device, only channel state data collected in a case that the signal-noise ratio SNR is greater than the first SNR threshold.

For example, it is possible to send, to the network side device, only channel state data collected in a case that the SNR is greater than or equal to the second SNR threshold.

For example, it is possible to send, to the network side device, only channel state data collected in a case that the signal to interference plus noise ratio SINR is greater than the first SINR threshold.

For example, it is possible to send, to the network side device, only channel state data collected in a case that the SINR is greater than or equal to the second SINR threshold.

For example, it is possible to send, to the network side device, only channel state data collected in a case that the interference is less than the first interference threshold.

For example, it is possible to send, to the network side device, only channel state data collected in a case that the interference is less than or equal to the second interference threshold.

For example, it is possible to send, to the network side device, only channel state data collected in a case that the SNR is greater than or equal to the second SNR threshold, and the interference is less than or equal to the second interference threshold.

It should be noted that, the first channel condition may be any combination of one or more of the foregoing. This is not limited in this embodiment of this application.

In some embodiments, in a case that the first information includes the first indication information, the method further includes:
The terminal determines, based on device capability information of the terminal, that the terminal does not have a first capability; and
the terminal sends second feedback information to the network side device, where the second feedback information represents that the terminal does not have the first capability and/or a reason why the terminal does not have the first capability.

In some embodiments, if the terminal determines that the collection requirement proposed by the network side device by using the first indication information cannot be supported, the terminal may not perform collection and reporting operations, and send the second feedback information to the network side device, to represent that the terminal does not have the first capability and/or the reason why the terminal does not have the first capability.

In some embodiments, in a case that the first information includes the second indication information, the method further includes:
The terminal receives sixth indication information sent by the network side device, where the sixth indication information represents that the network side device has completed collection; and
the terminal stops, based on the sixth indication information, sending the uplink reference signal.

In some embodiments, after receiving the second indication information, the terminal may send the uplink reference signal to the network side device, so that the network side device collects the channel state data used for positioning. After completing collection of the channel state data used for positioning, the network side device may send the sixth indication information to the terminal, and the terminal may determine, based on the sixth indication information, that the network side device does not need to receive the uplink reference signal, and may stop sending the uplink reference signal.

For example, when it is determined, based on the device capability information of the terminal, that the terminal does not support collection of the channel state data used for positioning, the network side may send only the second indication information to the terminal.

For example, when it is determined, based on the device capability information of the terminal, that the terminal supports collection of the channel state data used for positioning, but does not support collection of the channel state data that is used for positioning and that carries the location label, the network side may send the first indication information and/or the second indication information to the terminal, where the first indication information may indicate the terminal to collect the channel state data that does not carry the location label and that is used for positioning.

In some embodiments, the method further includes:
The terminal reports the device capability information of the terminal to the network side device.

In some embodiments, the terminal may report the device capability information of the terminal to the network side device in advance.

In some embodiments, the terminal may report the device capability information of the terminal before receiving the first indication information and/or the second indication information, so that the network side generates the first indication information based on the device capability information of the terminal, and sends the first indication information to the terminal. A requirement of the first indication information may be more suitable for the device capability information of the terminal.

In some embodiments, the terminal may report the device capability information of the terminal when accessing the network side device.

In some embodiments, the location label includes at least one of the following:
a physical location, a Time Of Arrival (TOA), a Time Difference Of Arrival (TDOA), an Angle-Of-Arrival (AOA), an Angle-Of-Departure (AOD), or a first identifier, where the first identifier indicates a Line Of Sight (LOS) or a Non Line Of Sight (NLOS).

In some embodiments, the channel state data carrying a location label may refer to channel state data carrying one or more of the following labels: a physical location, a TOA, a TDOA, an AOA, an AOD, a LOS, or an NLOS.

In some embodiments, the channel state data not carrying a location label may refer to channel state data carrying none of the following labels: a physical location, a TOA, a TDOA, an AOA, an AOD, a LOS, or an NLOS.

In this embodiment of this application, the terminal collects, based on the indication, the channel state data used for positioning, and/or sends the uplink reference signal, so that the network side device collects the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

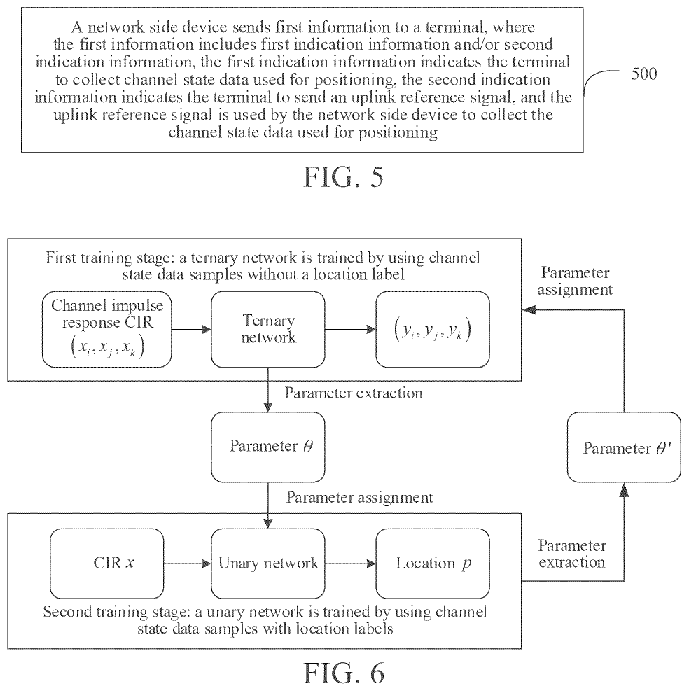

FIG. 5 is a second schematic flowchart of a data collection method according to an embodiment of this application. As shown in FIG. 5, the method includes the following processes.

Step 500: A network side device sends first information to a terminal.

The first information includes first indication information and/or second indication information, the first indication information indicates the terminal to collect channel state data used for positioning, the second indication information indicates the terminal to send an uplink reference signal, and the uplink reference signal is used by the network side device to collect the channel state data used for positioning.

In some embodiments, high-dimensional channel state data may be mapped to a low-dimensional manifold space (for example, two-dimensional) having the same location dimension. It may be considered that the mapping implements a principle of proximity reservation. For example, similar locations in an actual space have similar pieces of channel state data, and the similar pieces of channel state data have similar mapping in the low-dimensional manifold space. A subsequent location-based service may be replaced with a location in a manifold space.

Therefore, during training of an AI model for positioning, the channel state data may be used as a training sample.

In some embodiments, the AI technology can significantly improve positioning precision. In the wireless communication network, an input for the AI model may be channel state data from a to-be-positioned device such as a plurality of TRPs, for example, a channel impulse response, and an output of the AI model is location prediction information of the AI model for the to-be-positioned device, for example, a location prediction result or an intermediate feature quantity. The intermediate feature quantity may assist in location calculation. However, AI-based positioning precision enhancement requires a large amount of available training data with real labels, that is, channel state data samples with location labels. Collection of these data samples needs a large amount of resources. Relatively, a channel state data sample without a location label is easier to be obtained. For example, only channel state data of a user may be collected without collecting a location label.

In some embodiments, semi-supervised learning is a method for training an AI model by using some channel state data samples with location labels and some channel state data samples without a location label.

In some embodiments, the channel state data used for positioning includes channel state data carrying a location label and channel state data not carrying a location label.

In this embodiment of this application, the collected channel state data used for positioning may include data based on a small quantity of channel state data samples with location labels and a large quantity of channel state data samples without a location label, and is used for semi-supervised learning of the AI model.

In some embodiments, the network side device may send the first indication information to the terminal, so that the terminal determines, based on the first indication information, that the channel state data used for positioning needs to be collected, to collect, on a terminal side, the channel state data used for positioning.

In some embodiments, the network side device may send the second indication information to the terminal, so that the terminal sends the uplink reference signal based on the second indication information, and the network side device may collect the channel state data used for positioning based on the received uplink reference signal, to collect, on a network side, the channel state data used for positioning.

In some embodiments, the network side device may send the first indication information and the second indication information to the terminal, so that the terminal determines, based on the first indication information, that the channel state data used for positioning needs to be collected on the terminal side, and the terminal sends the uplink reference signal based on the second indication information. In this way, the network side device may collect the channel state data used for positioning based on the received uplink reference signal, and may collect the channel state data used for positioning on both sides of communication.

In an embodiment, the network side device may indicate the terminal to collect positioning data, that is, the network side device sends the first indication information to the terminal, where the first indication information requires the terminal to collect channel state data carrying a location label and channel state data not carrying a location label.

In an embodiment, the network side device may collect positioning data in collaboration with the terminal side. The network side device may collect channel state data not carrying a location label, and the terminal side may collect channel state data carrying a location label. For example, the network side device sends the first indication information and the second indication information to the terminal, requires, by using the first indication information, the terminal to collect the channel state data carrying a location label, and indicates, by using the second indication information, the terminal to send the uplink reference signal.

In an embodiment, the network side device may collect positioning data, including channel state data carrying a location label and channel state data not carrying a location label. The network side device may send the second indication information to the terminal, to indicate the terminal to send the uplink reference signal, and the network side device may collect the channel state data carrying a location label and the channel state data not carrying a location label based on the uplink reference signal.

In some embodiments, a manner in which the network side device obtains the location label may include: a location of the terminal is known in advance on a network side, and location information is obtained by using another positioning method, for example, a global positioning system. Conventional positioning methods include OTDOA positioning, Cell ID positioning, barometric pressure sensor positioning, WLAN positioning, TBS positioning, motion sensor positioning, Multi-RTT positioning, DL-AOD positioning, DL-TDOA positioning, UL-TDOA positioning, UL-AOA positioning, and the like.

In this embodiment of this application, by indicating the terminal to collect the channel state data used for positioning, and/or indicating the terminal to send the uplink reference signal, the network side device may collect, based on the received uplink reference signal, the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

In some embodiments, the first indication information includes at least one of following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection;
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

In some embodiments, the first indication information includes any one or more of the following:
a type identifier ID of data collection, for example, data that is indicated to be collected by using the first indication information is a time domain channel impulse response; or
a target task of data collection, for example, data that is indicated to be collected by using the first indication information is used for AI positioning; or
a time interval of data collection, for example, data collection is performed every A time units, where A is a positive integer; or
a space interval of data collection, for example, the terminal performs data collection once every time the terminal moves by B distance units, for example, performs sampling D times within C distance units, for example, performs sampling P times within F-E distance units, where B, C, D, E, F, and P are all positive integers; or
an amount of data collection, for example, T pieces of data are collected, for example, Y groups of data are collected, where T is a positive integer, and Y is a positive integer; or
a start time of data collection; or
an end time of data collection; or
duration of data collection; or
data accuracy of data collection, that is, precision of data expected to be collected; or
a data accuracy requirement reported after the data collection; or
format information reported after the data collection, for example, indicates that the collected data needs to be grouped, for example, data at times N1, N2, and N3 is grouped into one group (N1, N2, N3), where N1, N2, and N3 are all positive integers; or
a data compression indication reported after the data collection may indicate whether the data collected by the terminal is compressed first and then reported, for example, one bit, where when the bit is 1, it indicates that the data collected by the terminal needs to be compressed and then reported, and when the bit is 0, it indicates that the data collected by the terminal is directly reported without compression; or
downlink reference signal information for data collection may include: port information, time domain information, frequency domain information, or space domain information; or
a carrying indication of the location label may indicate whether the data collected by the terminal carries the location label, for example, one bit, where when the bit is 1, it indicates that the data collected by the terminal needs to carry the location label, and when the bit is 0, it indicates that the data collected by the terminal does not need to carry the location label; or
a carrying indication of timestamp information may indicate whether the data collected by the terminal carries the timestamp information, for example, one bit, where when the bit is 1, it indicates that the data collected by the terminal needs to carry the timestamp information, and when the bit is 0, it indicates that the data collected by the terminal does not need to carry the timestamp information; or
a carrying indication of channel estimation error information may indicate whether the data collected by the terminal carries the channel estimation error information, for example, one bit, where when the bit is 1, it indicates that the data collected by the terminal needs to carry the channel estimation error information, and when the bit is 0, it indicates that the data collected by the terminal does not need to carry the channel estimation error information; or
a carrying indication of location labeling error information may indicate whether the data collected by the terminal carries the location labeling error information, for example, one bit, where when the bit is 1, it indicates that the data collected by the terminal needs to carry the location labeling error information, and when the bit is 0, it indicates that the data collected by the terminal does not need to carry the location labeling error information; or
a carrying indication of reference signal measurement quality information may indicate whether the data collected by the terminal carries the reference signal measurement quality information, for example, one bit, where when the bit is 1, it indicates that the data collected by the terminal needs to carry the reference signal measurement quality information, and when the bit is 0, it indicates that the data collected by the terminal does not need to carry the reference signal measurement quality information; or
a carrying indication of motion state information of the terminal may indicate whether the data collected by the terminal carries corresponding motion state information, for example, one bit, where when the bit is 1, it indicates that the data collected by the terminal needs to carry the corresponding motion state information, and when the bit is 0, it indicates that the data collected by the terminal does not need to carry the corresponding motion state information, where the motion state information may include a motion speed, a motion acceleration, and the like; or
a data compression format, for example, indicates a data compression format in which the data collected by the terminal is compressed.

In some embodiments, one time unit may be one OFDM symbol, one slot, one subframe, one frame, one reference signal sending period, one microsecond, one millisecond, one second, one minute, one hour, or the like, and this is not limited in this embodiment of this application.

In some embodiments, one distance unit may be one centimeter, one decimeter, one meter, one kilometer, or the like, and this is not limited in this embodiment of this application.

In some embodiments, the second indication information includes resource information for transmitting the uplink reference signal, and the resource information includes at least one of the following:
port information, time domain information, frequency domain information, or space domain information.

In some embodiments, after receiving the second indication information, the terminal may transmit the uplink reference signal based on the resource information of the uplink reference signal.

In some embodiments, in a case that the first information includes the first indication information, the method further includes:
The network side device receives the channel state data that is used for positioning and that is sent by the terminal.

In some embodiments, after the network side device sends the first indication information to the terminal, the terminal may determine, based on device capability information of the terminal, whether a collection requirement and/or a reporting requirement proposed by the network side device by using the first indication information can be supported.

In some embodiments, if the terminal determines that the collection requirement and the reporting requirement proposed by the network side device by using the first indication information can be supported, the terminal may collect, based on a collection requirement in the first indication information, the channel state data used for positioning, and report, based on a reporting requirement in the first indication information, the channel state data used for positioning. In this way, the network side device may receive the channel state data that is used for positioning and that is sent by the terminal.

In some embodiments, if the terminal determines that the collection requirement proposed by the network side device by using the first indication information can be supported, but the reporting requirement is not supported, the terminal may collect the channel state data used for positioning based on the collection requirement in the first indication information, and report the channel state data used for positioning as much as possible based on the reporting requirement in the first indication information. For an aspect that does not meet the reporting requirement, the terminal reports the channel state data used for positioning based on a device capability of the terminal. In this way, the network side device may receive the channel state data that is used for positioning and that is sent by the terminal.

In some embodiments, if the terminal determines that the collection requirement proposed by the network side device by using the first indication information cannot be supported, the terminal may not perform collection and reporting operations.

In some embodiments, the channel state data received by the network side device includes at least one of the following:
data that meets the first indication information;
a location label of the data;
channel estimation error information corresponding to the data;
location labeling error information corresponding to the data;
reference signal measurement quality information corresponding to the data;
motion state information of the terminal;
timestamp information of data collection;
a transmission and reception point identifier TRP ID corresponding to the data;
a cell identifier ID corresponding to the data;
third indication information or fourth indication information, where the third indication information represents that the data carries the location label, and the fourth indication information represents that the data does not carry the location label;
fifth indication information, where the fifth indication information indicates that data compression has been performed on the data; and
a format of the data compression.

In some embodiments, the location labeling error information corresponding to the data may include a confidence and/or deviation range of the location label carried in the data. For example, a location error may be 3 meters or 1 meter.

In some embodiments, the location labeling error information corresponding to the data may include error indication information of the location label carried in the data, and may be one-bit information. For example, if an error is greater than a preset error threshold of the location label, an identifier 1 is reported for the bit, or otherwise, 0 is reported.

In some embodiments, the channel estimation error information corresponding to the data may include a confidence and/or deviation range of channel estimation carried in the data.

In some embodiments, the channel estimation error information corresponding to the data may include error indication information of the channel estimation carried in the data, and may be one-bit information. For example, if an error is greater than a preset error threshold of the channel estimation, an identifier 1 is reported for the bit, or otherwise, 0 is reported.

In some embodiments, the method further includes:
The network side device receives first feedback information; and
the network side device determines, based on the first feedback information, that the terminal has a first capability, where the first capability is a capability of providing the network side device with data conforming to the first indication information.

In some embodiments, if the terminal determines that the collection and reporting requirement proposed by the network side device by using the first indication information can be supported, the terminal may send the first feedback information to the network side device, to represent that the terminal supports the collection and reporting requirement proposed by the network side device by using the first indication information, and is about to report the collected channel state data used for positioning. In this way, the network side device may receive, on a corresponding resource, the channel state data reported by the terminal for positioning.

In some embodiments, if the terminal determines that the collection requirement and a part of the reporting requirement proposed by the network side device by using the first indication information can be supported, the terminal may send the first feedback information to the network side device, and may further carry an indication of the supported part of the reporting requirement in the first feedback information, to represent that the terminal supports the collection requirement and the part of the reporting requirement proposed by the network side device by using the first indication information, and is about to report the collected channel state data used for positioning. In this way, the network side device may receive, on a corresponding resource, the channel state data reported by the terminal for positioning.

In some embodiments, in a case that the first information includes the first indication information, the method further includes:
The network side device sends seventh indication information to the terminal, where the seventh indication information indicates a first transmission resource to the terminal, and the first transmission resource is a transmission resource of the channel state data used for positioning; and
the first transmission resource includes at least one of the following:
a time domain resource, a space domain resource, a frequency domain resource, or a port resource.

In some embodiments, the network side device may configure the first transmission resource for the terminal in advance before the terminal sends the channel state data used for positioning to the network side device, and the terminal may send the channel state data used for positioning to the network side device in the first transmission resource.

In some embodiments, in a case that the first information includes the first indication information, the method further includes:
The network side device receives second feedback information; and
the network side device determines, based on the second feedback information, that the terminal does not support a data collection requirement of the network side device and/or a reason why the terminal does not support the data collection requirement of the network side device.

In some embodiments, if the terminal determines that the collection requirement proposed by the network side device by using the first indication information cannot be supported, the terminal may not perform collection and reporting operations, and send the second feedback information to the network side device, to represent that the terminal does not have the first capability and/or the reason why the terminal does not have the first capability. After receiving the second feedback information, the network side device may determine that the terminal does not support a data collection requirement of the network side device and/or a reason why the terminal does not support the data collection requirement of the network side device.

In some embodiments, in a case that the first information includes the second indication information, the method further includes:
The network side device collects, based on the uplink reference signal, the channel state data used for positioning.

In some embodiments, after sending the second indication information to the terminal, the network side may receive the uplink reference signal sent by the terminal, and collect the channel state data used for positioning based on the uplink reference signal.

In some embodiments, the method further includes:
The network side device sends sixth indication information to the terminal in a case that collection is completed, where the sixth indication information indicates the terminal to stop sending the uplink reference signal.

In some embodiments, after completing collection of the channel state data used for positioning, the network side device may send the sixth indication information to the terminal, and the terminal may determine, based on the sixth indication information, that the network side device does not need to receive the uplink reference signal, and may stop sending the uplink reference signal.

In some embodiments, the method further includes:
The network side device receives device capability information reported by the terminal.

In some embodiments, the terminal may report the device capability information of the terminal to the network side device in advance.

In some embodiments, the terminal may report the device capability information of the terminal before receiving the first indication information and/or the second indication information, so that the network side generates the first indication information based on the device capability information of the terminal, and sends the first indication information to the terminal. A requirement of the first indication information may be more suitable for the device capability information of the terminal.

In some embodiments, the terminal may report the device capability information of the terminal when accessing the network side device.

For example, when it is determined, based on the device capability information of the terminal, that the terminal does not support collection of the channel state data used for positioning, the network side may send only the second indication information to the terminal.

For example, when it is determined, based on the device capability information of the terminal, that the terminal supports collection of the channel state data used for positioning, but does not support collection of the channel state data that is used for positioning and that carries the location label, the network side may send the first indication information and/or the second indication information to the terminal, where the first indication information may indicate the terminal to collect the channel state data that does not carry the location label and that is used for positioning.

In some embodiments, the network side device may indicate a terminal that can obtain accurate location information of the device to collect the channel state data carrying a location label, and indicate a terminal that cannot obtain the accurate location information to collect the channel state data not carrying a location label.

In some embodiments, the location label includes at least one of the following:
a physical location, a TOA, a TDOA, an AOA, an AOD, or a first identifier, where the first identifier indicates a LOS or an NLOS.

In some embodiments, the channel state data carrying a location label may refer to channel state data carrying one or more of the following labels: a physical location, a TOA, a TDOA, an AOA, an AOD, a LOS, or an NLOS.

Optionally, the channel state data not carrying a location label may refer to channel state data carrying none of the following labels: a physical location, a TOA, a TDOA, an AOA, an AOD, a LOS, or an NLOS.

In this embodiment of this application, by indicating the terminal to collect the channel state data used for positioning, and/or indicating the terminal to send the uplink reference signal, the network side device may collect, based on the received uplink reference signal, the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

In an embodiment, FIG. 6 is a schematic diagram of application of data collection according to an embodiment of this application. As shown in FIG. 6, when model training is performed based on the channel state data carrying a location label and the channel state data not carrying a location label that are collected in any one of the foregoing embodiments, the following may be performed.

### (a) First Training Stage

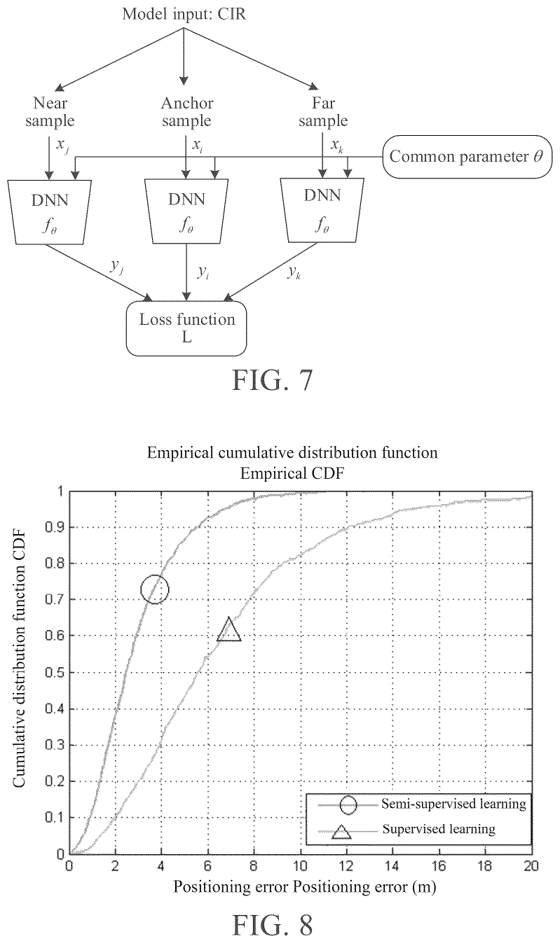

The first model is trained by using the channel state data samples without a location label. FIG. 7 is a schematic diagram of a structure of a first model according to an embodiment of this application. As shown in FIG. 7, the first model is a ternary network, a learning rate is L1, a quantity of times of training is E1, and a quantity of samples of each training is S1. Therefore, a model parameter θ of any of three branches of the first model may be stored.

In some embodiments, a loss function of the ternary network may include a type of function, that is, a function that can meet the following condition: a distance D1 between a far sample yk (an output of a second branch) and an anchor sample yi (an output of a first branch) in a low-dimensional space Y is as large as possible, a distance D2 between a near sample yj (an output of a third branch) and the anchor sample yi (the output of the first branch) is as small as possible, and D1-D2 is less than M.

In some embodiments, the loss function of the ternary network may be:

$$L = arg {min}_{θ} [ \frac{1}{N} {\sum }_{n = 1}^{N} max ( 0 , M + ‖ {f}_{θ} ( {x}_{i}^{n} ) - {f}_{θ} ( {x}_{j}^{n} ) ‖ - ‖ {f}_{θ} ( {x}_{i}^{n} ) - {f}_{θ} ( {x}_{k}^{n} ) ‖ ) ] ,$$

M is a hyperparameter, N is a quantity of samples in one batch. xᵢⁿ, xⱼⁿ, and xₖⁿ respectively represent CIR of an anchor sample, a near sample, and a far sample of an n^{th} group of samples in one batch; and the parameter M and other hyperparameters may be used to obtain an optimal value of M through ablation study, f_{θ}(xᵢⁿ) represents the anchor sample yi (the output of the first branch), f_{θ}(xⱼⁿ) represents the near sample yj (the output of the third branch), and f_{θ}(xₖⁿ) represents the far sample yk (the output of the second branch).

### (b) Second Training Stage

The model parameter θ obtained in the first training stage is used as an initial parameter of a second model, where the second model and one of the branches of the first model have a same structure; the second model is trained by using the channel state data samples with location labels, the second model is a unary model, a learning rate is L2, a quantity of times of training is E2, and a quantity of samples of each training is S2; a model parameter θ′ of the second model is stored; and the model parameter θ′ obtained in the second stage is used as an initial parameter of each branch of the first model, and return to a).

In some embodiments, a loss function of a unary network may include a type of function, that is, a function that can meet the following condition: a distance between a model predicted value (mapping of a channel state data sample with a location label in the low-dimensional manifold space, that is, an output of the unary network) and a real label of the channel state data sample is as small as possible, and the distance may be: an average absolute distance, an Euclidean distance, or the like.

### (c) Iterate in Sequence Until the Second Model Reaches Target Positioning Precision on a Test Set

In some embodiments, semi-supervised learning is performed based on a data set including the channel state data carrying a location label and the channel state data not carrying a location label that are collected in any one of the foregoing embodiments, to obtain a positioning model through training. FIG. 8 is a schematic diagram of positioning precision according to an embodiment of this application. As shown in FIG. 8, the positioning model obtained through semi-supervised learning may be compared with a positioning model obtained through supervised learning, and it may be obviously determined that positioning precision of the positioning model obtained through semi-supervised learning is higher. Refer to Table 1 below.

TABLE 1

| Frequency | | | | | | |
|---|---|---|---|---|---|---|
| band | Scenario | Case | 50% | 67% | 80% | 90% |
| FR1 | DH | Semi-supervised learning, M = 2 | 2.47 | 3.25 | 4.26 | 5.51 |
| | | Channel state data samples with | | | | |
| | | location labels: 1000 | | | | |
| | | Channel state data samples without | | | | |
| | | a location label: 30000 | | | | |
| | | Supervised learning | 5.56 | 7.49 | 9.38 | 12.06 |
| | | Channel state data samples with | | | | |
| | | location labels: 1000 | | | | |
| | | Channel state data samples without | | | | |
| | | a location label: 0 | | | | |

50%, 67%, 80%, and 90% are cumulative probability density distributions of positioning errors. Based on a simulation result, the semi-supervised learning method in this solution can significantly improve positioning precision by using the data collection method.

The data collection method provided in the embodiments of this application may be performed by a data collection apparatus. In the embodiments of this application, a data collection apparatus provided in the embodiments of this application is described by using an example in which the data collection apparatus performs the data collection method.

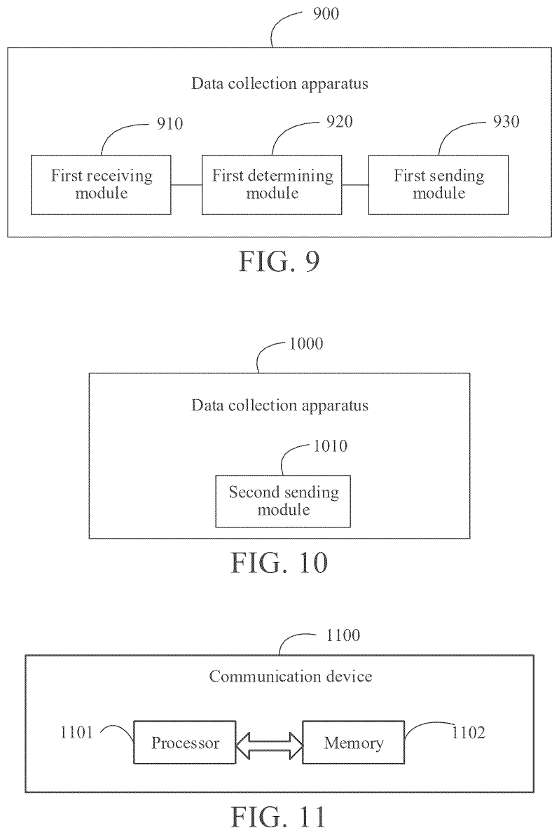

FIG. 9 is a first schematic diagram of a structure of a data collection apparatus according to an embodiment of this application. As shown in FIG. 9, the apparatus 900 includes: a first receiving module 910, a first determining module 920, and a first sending module 930, where:
the first receiving module 910 is configured to receive first information, where the first information includes first indication information and/or second indication information, the first indication information indicates the terminal to collect channel state data used for positioning, and the second indication information indicates the terminal to send an uplink reference signal;
the first determining module 920 is configured to: in a case that the first information includes the first indication information, determine that the channel state data used for positioning needs to be collected; and
the first sending module 930 is configured to send the uplink reference signal in a case that the first information includes the second indication information, where the uplink reference signal is used by a network side device to collect the channel state data used for positioning.

The channel state data used for positioning includes channel state data carrying a location label and channel state data not carrying a location label.

In this embodiment of this application, the terminal collects, based on the indication, the channel state data used for positioning, and/or sends the uplink reference signal, so that the network side device collects the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

The data collection apparatus provided in this embodiment of this application can implement the processes in the foregoing method embodiments, and a same technical effect is achieved. To avoid repetition, details are not described herein again.

In some embodiments, the first indication information includes at least one of following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection;
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

In some embodiments, the second indication information includes resource information for transmitting the uplink reference signal, and the resource information includes at least one of the following:
port information, time domain information, frequency domain information, or space domain information.

In some embodiments, the apparatus further includes:
a second determining module, configured to send the channel state data used for positioning to the network side device in a case of having a first capability, where the first capability is a capability of providing the network side device with data conforming to the first indication information.

In some embodiments, the channel state data sent by the terminal to the network side device includes at least one of the following:
data that meets the first indication information;
a location label of the data;
channel estimation error information corresponding to the data;
location labeling error information corresponding to the data;
reference signal measurement quality information corresponding to the data;
motion state information of the terminal;
timestamp information of data collection;
third indication information or fourth indication information, where the third indication information represents that the data carries the location label, and the fourth indication information represents that the data does not carry the location label;
fifth indication information, where the fifth indication information represents that data compression has been performed on the data; and
a format of the data compression.

In some embodiments, the apparatus further includes:
a fourth sending module, configured to send first feedback information to the network side device, where the first feedback information represents that the terminal has the first capability.

In some embodiments, a third sending module is configured to perform at least one of the following:
sending the channel state data to the network side device based on a time period, where the time period is determined based on an indication of the network side device, predefined based on a protocol, or preset;
sending the channel state data to the network side device based on a collection period, where each collection period corresponds to a second amount of channel state data, and the second amount is determined based on an indication of the network side device, predefined based on a protocol, or preset;
sending, based on a transmission resource allocated by the network side device for the channel state data used for positioning, a first amount of channel state data to the network side device, where the first amount is a maximum value at which a size of the transmission resource supports transmission of the channel state data;
after duration of collection reaches a target collection time, sending, to the network side device, channel state data collected within the duration; or
after an amount of collected channel state data reaches a target amount, sending, to the network side device, the target amount of channel state data.

In some embodiments, a third sending module is configured to perform at least one of the following:
sending the channel state data used for positioning to the network side device in a first transmission resource, where the first transmission resource is determined based on an indication of the network side device.

The first transmission resource includes at least one of the following:
a time domain resource, a space domain resource, a frequency domain resource, or a port resource.

In some embodiments, a third sending module is configured to perform at least one of the following:
sending channel state data that meets a first condition to the network side device.

The channel state data that meets the first condition includes at least one of the following:
confidence of the location label of the channel state data is within a confidence range;
a deviation range of the location label of the channel state data is less than a deviation threshold; and
the channel state data is collected under a first channel condition.

The first channel condition includes at least one of the following:
a reference signal receiving power RSRP is greater than a first RSRP threshold;
the RSRP is greater than or equal to a second RSRP threshold;
a signal-noise ratio SNR is greater than a first SNR threshold;
the SNR is greater than or equal to a second SNR threshold;
a signal to interference plus noise ratio SINR is greater than a first SINR threshold;
the SINR is greater than or equal to a second SINR threshold;
an interference is less than a first interference threshold; and
the interference is less than or equal to a second interference threshold.

In some embodiments, the apparatus further includes:
a third determining module, configured to: in a case that the first information includes the first indication information, determine, based on device capability information of the terminal, that the terminal does not have a first capability; and
a fifth sending module, configured to send second feedback information to the network side device, where the second feedback information represents that the terminal does not have the first capability and/or a reason why the terminal does not have the first capability.

In some embodiments, the apparatus further includes:
a second receiving module, configured to: in a case that the first information includes the second indication information, receive sixth indication information sent by the network side device, where the sixth indication information represents that the network side device has completed collection; and
a stop module, configured to stop, based on the sixth indication information, sending the uplink reference signal.

In some embodiments, the apparatus further includes:
a first reporting module, configured to report the device capability information of the terminal to the network side device.

In some embodiments, the location label includes at least one of the following:
a physical location, a TOA, a TDOA, an AOA, an AOD, or a first identifier, where the first identifier indicates a LOS or an NLOS.

In this embodiment of this application, the terminal collects, based on the indication, the channel state data used for positioning, and/or sends the uplink reference signal, so that the network side device collects the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

The data collection apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, a Network Attached Storage (NAS), and the like. This is not specifically limited in this embodiment of this application.

The data collection apparatus provided in this embodiment of this application can implement the processes in the method embodiment of FIG. 4, and a same technical effect is achieved. To avoid repetition, details are not described herein again.

FIG. 10 is a second schematic diagram of a structure of a data collection apparatus according to an embodiment of this application. As shown in FIG. 10, the apparatus 1000 includes: a second sending module 1010, where:
the second sending module 1010 is configured to send first information to a terminal.

The first information includes first indication information and/or second indication information, the first indication information indicates the terminal to collect channel state data used for positioning, the second indication information indicates the terminal to send an uplink reference signal, and the uplink reference signal is used by the network side device to collect the channel state data used for positioning.

The channel state data used for positioning includes channel state data carrying a location label and channel state data not carrying a location label.

In this embodiment of this application, by indicating the terminal to collect the channel state data used for positioning, and/or indicating the terminal to send the uplink reference signal, the network side device may collect, based on the received uplink reference signal, the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

The data collection apparatus provided in this embodiment of this application can implement the processes in the foregoing method embodiments, and a same technical effect is achieved. To avoid repetition, details are not described herein again.

In some embodiments, the first indication information includes at least one of following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection;
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

In some embodiments, the second indication information includes resource information for transmitting the uplink reference signal, and the resource information includes at least one of the following:
port information, time domain information, frequency domain information, or space domain information.

In some embodiments, the apparatus further includes:
a third receiving module, configured to: in a case that the first information includes the first indication information, receive the channel state data that is used for positioning and that is sent by the terminal.

In some embodiments, the channel state data received by the network side device includes at least one of the following:
data that meets the first indication information;
a location label of the data;
channel estimation error information corresponding to the data;
location labeling error information corresponding to the data;
reference signal measurement quality information corresponding to the data;
motion state information of the terminal;
timestamp information of data collection;
information represents that the data does not carry the location label;
fifth indication information, where the fifth indication information indicates that data
compression has been performed on the data; and
a format of the data compression.

In some embodiments, the apparatus further includes:
a fourth receiving module, configured to receive first feedback information; and
a fourth determining module, configured to determine, based on the first feedback information, that the terminal has a first capability, where the first capability is a capability of providing the network side device with data conforming to the first indication information.

In some embodiments, the apparatus further includes:
a sixth sending module, configured to send seventh indication information to the terminal in a case that the first information includes the first indication information, where the seventh indication information indicates a first transmission resource to the terminal, and the first transmission resource is a transmission resource of the channel state data used for positioning.

The first transmission resource includes at least one of the following:
a time domain resource, a space domain resource, a frequency domain resource, or a port resource.

In some embodiments, the apparatus further includes:
a fifth receiving module, configured to: in a case that the first information includes the first indication information, receive second feedback information; and
a fifth determining module, configured to determine, based on the second feedback information, that the terminal does not support a data collection requirement of the network side device and/or a reason why the terminal does not support the data collection requirement of the network side device.

In some embodiments, the method further includes:
a collection module, configured to: in a case that the first information includes the second indication information, collect, based on the uplink reference signal, the channel state data used for positioning.

In some embodiments, the apparatus further includes:
a seventh sending module, configured to send sixth indication information to the terminal in a case that collection is completed, where the sixth indication information indicates the terminal to stop sending the uplink reference signal.

In some embodiments, the apparatus further includes:
a sixth receiving module, configured to receive device capability information reported by the terminal.

In some embodiments, the location label includes at least one of the following:
a physical location, a TOA, a TDOA, an AOA, an AOD, or a first identifier, where the first identifier indicates a LOS or an NLOS.

In this embodiment of this application, by indicating the terminal to collect the channel state data used for positioning, and/or indicating the terminal to send the uplink reference signal, the network side device may collect, based on the received uplink reference signal, the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

The data collection apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The another device may be a server, an NAS, and the like. This is not specifically limited in this embodiment of this application.

The data collection apparatus provided in this embodiment of this application can implement the processes in the method embodiment of FIG. 5, and a same technical effect is achieved. To avoid repetition, details are not described herein again.

For example, FIG. 11 is a schematic diagram of a structure of a communication device according to an embodiment of this application. As shown in FIG. 11, an embodiment of this application further provides a communication device 1100, including a processor 1101 and a memory 1102. The memory 1102 stores a program or an instruction that can be run on the processor 1101. For example, when the communication device 1100 is a terminal, the program or the instruction is executed by the processor 1101 to implement the steps of the data collection method embodiments corresponding to the terminal side, and a same technical effect can be achieved. In a case that the communication device 1100 is a network side device, when the program or the instruction is executed by the processor 1101, the steps of the data collection method embodiment corresponding to the network side device are implemented, and a same technical effect can be achieved. To avoid repetition, details are not described herein again.

An embodiment of this application further provides a terminal, including a processor and a communication interface, where the communication interface is configured to:
receive first information, where the first information includes first indication information and/or second indication information, the first indication information indicates the terminal to collect channel state data used for positioning, and the second indication information indicates the terminal to send an uplink reference signal;
the processor is configured to:
in a case that the first information includes the first indication information, determine that the channel state data used for positioning needs to be collected; and
the communication interface is configured to:
send the uplink reference signal in a case that the first information includes the second indication information, where the uplink reference signal is used by a network side device to collect the channel state data used for positioning.

The channel state data used for positioning includes channel state data carrying a location label and channel state data not carrying a location label.

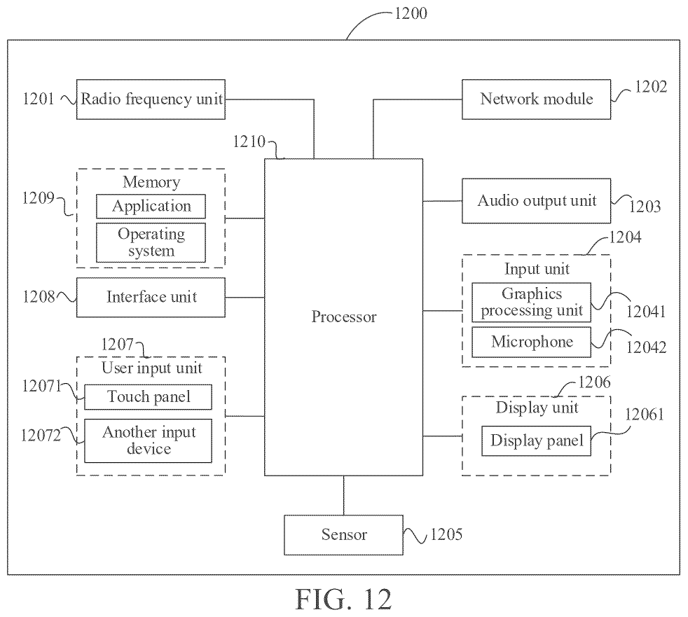

The terminal embodiment is corresponding to the terminal side method embodiment, each implementation process and implementation of the method embodiment may be applied to the terminal embodiment, and a same technical effect can be achieved. For example, FIG. 12 is a schematic diagram of a hardware structure of a terminal according to an embodiment of this application.

The terminal 1200 includes but is not limited to: at least some of the following components: a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art may understand that the terminal 1200 may further include a power supply (such as a battery) that supplies power to each component. The power supply may be logically connected to the processor 1210 through a power management system, to implement functions such as charging and discharging management, and power consumption management by using the power management system. The terminal structure shown in FIG. 12 constitutes no limitation on the terminal, and the terminal may include more or fewer components than those shown in the figure, or combine some components, or have different component arrangements. Details are not described herein again.

It should be understood that in this embodiment of this application, the input unit 1204 may include a Graphics Processing Unit (GPU) 12041 and a microphone 12042. The graphics processing unit 12041 processes image data of a static picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein again.

In this embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may be a volatile memory or a non-volatile memory, or the memory 1209 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1209 in this embodiment of this application includes but is not limited to these memories and any memory of another proper type.

The processor 1210 may include one or more processing units. In some embodiments, an application processor and a modem processor are integrated into the processor 1210. The application processor mainly processes an operating system, a user interface, an application, or the like. The modem processor mainly processes a wireless communication signal, for example, a baseband processor. It can be understood that the foregoing modem processor may not be integrated into the processor 1210.

The processor 1210 is configured to:
receive first information, where the first information includes first indication information and/or second indication information, the first indication information indicates the terminal to collect channel state data used for positioning, and the second indication information indicates the terminal to send an uplink reference signal;
in a case that the first information includes the first indication information, determine that the channel state data used for positioning needs to be collected; and
send the uplink reference signal in a case that the first information includes the second indication information, where the uplink reference signal is used by a network side device to collect the channel state data used for positioning.

The channel state data used for positioning includes channel state data carrying a location label and channel state data not carrying a location label.

In this embodiment of this application, the terminal collects, based on the indication, the channel state data used for positioning, and/or sends the uplink reference signal, so that the network side device collects the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

In some embodiments, the first indication information includes at least one of following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection;
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

In some embodiments, the second indication information includes resource information for transmitting the uplink reference signal, and the resource information includes at least one of the following:
port information, time domain information, frequency domain information, or space domain information.

In some embodiments, the processor 1210 is configured to:
in a case that the first information includes the first indication information, send the channel state data used for positioning to the network side device in a case of having a first capability, where the first capability is a capability of providing the network side device with data conforming to the first indication information.

In some embodiments, the channel state data sent by the terminal to the network side device includes at least one of the following:
data that meets the first indication information;
a location label of the data;
channel estimation error information corresponding to the data;
location labeling error information corresponding to the data;
reference signal measurement quality information corresponding to the data;
motion state information of the terminal;
timestamp information of data collection;
a transmission and reception point identifier TRP ID corresponding to the data;
a cell identifier ID corresponding to the data;
third indication information or fourth indication information, where the third indication information represents that the data carries the location label, and the fourth indication information represents that the data does not carry the location label;
fifth indication information, where the fifth indication information represents that data compression has been performed on the data; and
a format of the data compression.

In some embodiments, the processor 1210 is configured to:
send first feedback information to the network side device, where the first feedback information represents that the terminal has the first capability.

In some embodiments, the processor 1210 is configured to perform at least one of the following:
sending the channel state data to the network side device based on a time period, where the time period is determined based on an indication of the network side device, predefined based on a protocol, or preset;
sending the channel state data to the network side device based on a collection period, where each collection period corresponds to a second amount of channel state data, and the second amount is determined based on an indication of the network side device, predefined based on a protocol, or preset;
sending, based on a transmission resource allocated by the network side device for the channel state data used for positioning, a first amount of channel state data to the network side device, where the first amount is a maximum value at which a size of the transmission resource supports transmission of the channel state data;
after duration of collection reaches a target collection time, sending, to the network side device, channel state data collected within the duration; or
after an amount of collected channel state data reaches a target amount, sending, to the network side device, the target amount of channel state data.

In some embodiments, the processor 1210 is configured to perform at least one of the following:
sending the channel state data used for positioning to the network side device in a first transmission resource, where the first transmission resource is determined based on an indication of the network side device.

The first transmission resource includes at least one of the following:
a time domain resource, a space domain resource, a frequency domain resource, or a port resource.

In some embodiments, the processor 1210 is configured to perform at least one of the following:
sending channel state data that meets a first condition to the network side device.

The channel state data that meets the first condition includes at least one of the following:
confidence of the location label of the channel state data is within a confidence range;
a deviation range of the location label of the channel state data is less than a deviation threshold; and
the channel state data is collected under a first channel condition.

The first channel condition includes at least one of the following:
a reference signal receiving power RSRP is greater than a first RSRP threshold;
the RSRP is greater than or equal to a second RSRP threshold;
a signal-noise ratio SNR is greater than a first SNR threshold;
the SNR is greater than or equal to a second SNR threshold;
a signal to interference plus noise ratio SINR is greater than a first SINR threshold;
the SINR is greater than or equal to a second SINR threshold;
an interference is less than a first interference threshold; and
the interference is less than or equal to a second interference threshold.

In some embodiments, the processor 1210 is configured to:
in a case that the first information includes the first indication information, determine, based on device capability information of the terminal, that the terminal does not have a first capability; and
send second feedback information to the network side device, where the second feedback information represents that the terminal does not have the first capability and/or a reason why the terminal does not have the first capability.

In some embodiments, the processor 1210 is configured to:
in a case that the first information includes the second indication information, receive sixth indication information sent by the network side device, where the sixth indication information represents that the network side device has completed collection; and
stop, based on the sixth indication information, sending the uplink reference signal.

In some embodiments, the processor 1210 is configured to:
report the device capability information of the terminal to the network side device.

In some embodiments, the location label includes at least one of the following:
a physical location, a TOA, a TDOA, an AOA, an AOD, or a first identifier, where the first identifier indicates a LOS or an NLOS.

In this embodiment of this application, the terminal collects, based on the indication, the channel state data used for positioning, and/or sends the uplink reference signal, so that the network side device collects the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

An embodiment of this application further provides a network side device, including a processor and a communication interface. The communication interface is configured to:
send first information to a terminal.

The first information includes first indication information and/or second indication information, the first indication information indicates the terminal to collect channel state data used for positioning, the second indication information indicates the terminal to send an uplink reference signal, and the uplink reference signal is used by the network side device to collect the channel state data used for positioning.

The channel state data used for positioning includes channel state data carrying a location label and channel state data not carrying a location label.

This network side device embodiment is corresponding to the foregoing method embodiment of the network side device. Each implementation process and implementation of the foregoing method embodiment may be applicable to this network side device embodiment, and a same technical effect can be achieved.

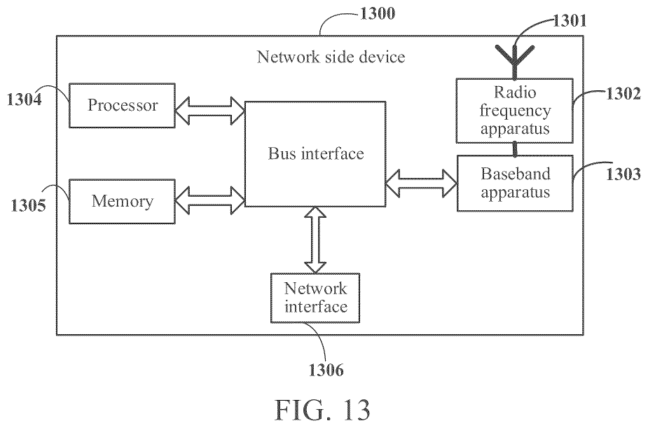

An embodiment of this application further provides a network side device. FIG. 13 is a schematic diagram of a hardware structure of a network side device according to an embodiment of this application. As shown in FIG. 13, the network side device 1300 includes: an antenna 1301, a radio frequency apparatus 1302, a baseband apparatus 1303, a processor 1304, and a memory 1305. The antenna 1301 is connected to the radio frequency apparatus 1302. In an uplink direction, the radio frequency apparatus 1302 receives information by using the antenna 1301, and sends the received information to the baseband apparatus 1303 for processing. In a downlink direction, the baseband apparatus 1303 processes to-be-sent information, and sends the to-be-sent information to the radio frequency apparatus 1302. After processing the received information, the radio frequency apparatus 1302 sends the information through the antenna 1301.

In the foregoing embodiment, the method performed by the network side device may be implemented in a baseband apparatus 1303. The baseband apparatus 1303 includes a baseband processor.

For example, the baseband apparatus 1303 may include at least one baseband board. A plurality of chips are disposed on the baseband board. As shown in FIG. 13, one chip is, for example, a baseband processor, and is connected to the memory 1305 by using a bus interface, to invoke a program in the memory 1305 to perform the operations of the network device shown in the foregoing method embodiment.

The network side device may further include a network interface 1306. The interface is, for example, a Common Public Radio Interface (CPRI).

For example, the network side device 1300 in this embodiment of the present application further includes: an instruction or a program stored in the memory 1305 and runnable on the processor 1304. The processor 1304 invokes the instruction or the program in the memory 1305 to perform the method performed by the modules shown in FIG. 10, and a same technical effect is achieved. To avoid repetition, details are not described herein again.

The processor 1304 is configured to:
send first information to a terminal.

The first information includes first indication information and/or second indication information, the first indication information indicates the terminal to collect channel state data used for positioning, the second indication information indicates the terminal to send an uplink reference signal, and the uplink reference signal is used by the network side device to collect the channel state data used for positioning.

The channel state data used for positioning includes channel state data carrying a location label and channel state data not carrying a location label.

In this embodiment of this application, by indicating the terminal to collect the channel state data used for positioning, and/or indicating the terminal to send the uplink reference signal, the network side device may collect, based on the received uplink reference signal, the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

In some embodiments, the first indication information includes at least one of following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection;
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

In some embodiments, the second indication information includes resource information for transmitting the uplink reference signal, and the resource information includes at least one of the following:
port information, time domain information, frequency domain information, or space domain information.

In some embodiments, the processor 1304 is configured to:
in a case that the first information includes the first indication information, receive the channel state data that is used for positioning and that is sent by the terminal.

In some embodiments, the channel state data received by the network side device includes at least one of the following:
data that meets the first indication information;
a location label of the data;
channel estimation error information corresponding to the data;
location labeling error information corresponding to the data;
reference signal measurement quality information corresponding to the data;
motion state information of the terminal;
timestamp information of data collection;
a transmission and reception point identifier TRP ID corresponding to the data;
a cell identifier ID corresponding to the data;
third indication information or fourth indication information, where the third indication information represents that the data carries the location label, and the fourth indication information represents that the data does not carry the location label;
fifth indication information, where the fifth indication information indicates that data compression has been performed on the data; and
a format of the data compression.

In some embodiments, the processor 1304 is configured to:
receive first feedback information; and
determine, based on the first feedback information, that the terminal has a first capability, where the first capability is a capability of providing the network side device with data conforming to the first indication information.

In some embodiments, the processor 1304 is configured to:
send seventh indication information to the terminal in a case that the first information includes the first indication information, where the seventh indication information indicates a first transmission resource to the terminal, and the first transmission resource is a transmission resource of the channel state data used for positioning.

The first transmission resource includes at least one of the following:
a time domain resource, a space domain resource, a frequency domain resource, or a port resource.

In some embodiments, the processor 1304 is configured to:
in a case that the first information includes the first indication information, receive second feedback information; and
determine, based on the second feedback information, that the terminal does not support a data collection requirement of the network side device and/or a reason why the terminal does not support the data collection requirement of the network side device.

In some embodiments, the processor 1304 is configured to:
in a case that the first information includes the second indication information, collect, based on the uplink reference signal, the channel state data used for positioning.

In some embodiments, the processor 1304 is configured to:
send sixth indication information to the terminal in a case that collection is completed, where the sixth indication information indicates the terminal to stop sending the uplink reference signal.

In some embodiments, the processor 1304 is configured to:
receive device capability information reported by the terminal.

In some embodiments, the location label includes at least one of the following:
a physical location, a TOA, a TDOA, an AOA, an AOD, or a first identifier, where the first identifier indicates a line of sight LOS or a non line of sight NLOS.

In this embodiment of this application, by indicating the terminal to collect the channel state data used for positioning, and/or indicating the terminal to send the uplink reference signal, the network side device may collect, based on the received uplink reference signal, the channel state data used for positioning. The collected channel state data used for positioning includes channel state data carrying a location label, and further includes easily collected channel state data not carrying a location label. In this way, a large amount of channel state data not carrying a location label can be provided as data samples for AI model training used for positioning, a scale of training samples is increased, positioning accuracy of a trained AI model is improved, and positioning precision is improved.

An embodiment of this application further provides a readable storage medium. The readable storage medium stores a program or an instruction, and when the program or the instruction is executed by a processor, the processes of the foregoing embodiments of the data collection method are implemented, and a same technical effect can be achieved. To avoid repetition, details are not described herein again.

The processor is a processor in the terminal in the foregoing embodiment. The readable storage medium includes a computer-readable storage medium, such as a computer ROM, an RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiments of the data collection method, and a same technical effect can be achieved. To avoid repetition, details are not described herein again.

It should be understood that the chip mentioned in this embodiment of this application may be referred to as a system-level chip, a system chip, a chip system, or an on-chip system chip.

An embodiment of this application further provides a computer program/program product, the computer program/program product is stored in a storage medium, and the computer program/program product is executed by at least one processor to implement the processes of the foregoing embodiment of the data collection method, and a same technical effect can be achieved. To avoid repetition, details are not described herein again.

An embodiment of this application further provides a data collection system, including: a terminal and a network side device, where the terminal may be configured to perform the steps of the data collection method corresponding to the terminal side, and the network side device may be configured to perform the steps of the data collection method corresponding to the network side device.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element preceded by a statement “includes a . . . ” does not preclude the presence of additional identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of this application essentially or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air-conditioner, a network device, or the like) to perform the method described in the embodiments of this application.

The embodiments of this application are described above with reference to the accompanying drawings, but this application is not limited to the foregoing implementations, and the foregoing implementations are only illustrative and not restrictive. Under the enlightenment of this application, a person of ordinary skill in the art can make many forms without departing from the purpose of this application and the protection scope of the claims, all of which fall within the protection of this application.

What is claimed is:

1. A data collection method, comprising:
receiving, by a terminal, first information, wherein: the first information comprises first indication information or second indication information, the first indication information indicates the terminal to collect channel state data used for positioning, and the second indication information indicates the terminal to send an uplink reference signal;
when the first information comprises the first indication information, determining, by the terminal, that the channel state data used for positioning needs to be collected; and
sending, by the terminal, the uplink reference signal when the first information comprises the second indication information,
wherein:
the uplink reference signal is used by a network side device to collect the channel state data used for positioning, and
the channel state data used for positioning comprises channel state data carrying a location label and channel state data not carrying a location label.

2. The data collection method according to claim 1, wherein the first indication information comprises at least one of the following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection.
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

3. The data collection method according to claim 1, wherein the second indication information comprises resource information for transmitting the uplink reference signal, and the resource information comprises at least one of the following:
port information, time domain information, frequency domain information, or space domain information.

4. The data collection method according to of claim 1, wherein when the first information comprises the first indication information, the method further comprises:
sending, by the terminal, the channel state data used for positioning to the network side device in response to having a first capability, wherein the first capability is a capability of providing the network side device with data conforming to the first indication information.

5. The data collection method according to claim 4, wherein the channel state data sent by the terminal to the network side device comprises at least one of the following:
data that meets requirements of the first indication information;
a location label of the data;
channel estimation error information corresponding to the data;
location labeling error information corresponding to the data;
reference signal measurement quality information corresponding to the data;
motion state information of the terminal;
timestamp information of data collection;
a Transmission and Reception Point Identifier (TRP ID) corresponding to the data;
a cell identifier ID corresponding to the data;
third indication information or fourth indication information, wherein the third indication information represents that the data carries the location label, and the fourth indication information represents that the data does not carry the location label;
fifth indication information, wherein the fifth indication information represents that data compression has been performed on the data; or
a format of the data compression.

6. The data collection method according to claim 4, further comprising:
sending, by the terminal, first feedback information to the network side device, wherein the first feedback information represents that the terminal has the first capability.

7. The data collection method according to claim 4, wherein sending, by the terminal, the channel state data used for positioning to the network side device comprises at least one of the following:
sending, by the terminal, the channel state data to the network side device based on a time period, wherein the time period is determined based on an indication of the network side device, predefined based on a protocol, or preset;
sending, by the terminal, the channel state data to the network side device based on a collection period, wherein each collection period corresponds to a second amount of channel state data, and the second amount is determined based on an indication of the network side device, predefined based on a protocol, or preset;
sending, by the terminal based on a transmission resource allocated by the network side device for the channel state data used for positioning, a first amount of channel state data to the network side device, wherein the first amount is a maximum value at which a size of the transmission resource supports transmission of the channel state data;
after duration of collection reaches a target collection time, sending, by the terminal to the network side device, channel state data collected within the duration; or
after an amount of collected channel state data reaches a target amount, sending, by the terminal to the network side device, the target amount of channel state data.

8. The data collection method according to claim 4, wherein sending, by the terminal, the channel state data used for positioning to the network side device comprises:
sending, by the terminal, the channel state data used for positioning to the network side device in a first transmission resource, wherein the first transmission resource is determined based on an indication of the network side device; and
the first transmission resource comprises at least one of the following:
a time domain resource, a space domain resource, a frequency domain resource, or a port resource.

9. The data collection method according to claim 4,
wherein:
sending, by the terminal, the channel state data used for positioning to the network side device comprises:
sending, by the terminal, channel state data that meets a first condition to the network side device;
the channel state data that meets the first condition comprises at least one of the following:
confidence of the location label of the channel state data is within a confidence range,
a deviation range of the location label of the channel state data is less than a deviation threshold, or
the channel state data is collected under a first channel condition; and
the first channel condition comprises at least one of the following:
a Reference Signal Receiving Power (RSRP) is greater than a first RSRP threshold;
the RSRP is greater than or equal to a second RSRP threshold;
a Signal-Noise Ratio (SNR) is greater than a first SNR threshold;
the SNR is greater than or equal to a second SNR threshold;
a Signal to Interference plus Noise Ratio (SINR) is greater than a first SINR threshold;
the SINR is greater than or equal to a second SINR threshold;
an interference is less than a first interference threshold; or
the interference is less than or equal to a second interference threshold.

10. The data collection method according to claim 1, wherein when the first information comprises the first indication information, the method further comprises:
determining, by the terminal based on device capability information of the terminal, that the terminal does not have a first capability; and
sending, by the terminal, second feedback information to the network side device, wherein the second feedback information represents that the terminal does not have the first capability or a reason why the terminal does not have the first capability.

11. The data collection method according to claim 1, wherein when the first information comprises the second indication information, the method further comprises:
receiving, by the terminal, sixth indication information sent by the network side device, wherein the sixth indication information represents that the network side device has completed collection; and
stopping, by the terminal based on the sixth indication information, sending the uplink reference signal.

12. The data collection method according to claim 1, further comprising:
reporting, by the terminal, the device capability information of the terminal to the network side device.

13. The data collection method according to claim 1, wherein the location label comprises at least one of the following:
a physical location, a Time Of Arrival (TOA), a Time Difference Of Arrival (TDOA), an Angle-Of-Arrival (AOA), an Angle-Of-Departure (AOD), or a first identifier, wherein the first identifier indicates a Line Of Sight (LOS) or a Non Line Of Sight (NLOS).

14. A data collection method, comprising:
sending, by a network side device, first information to a terminal, wherein:
the first information comprises first indication information or second indication information, the first indication information indicates the terminal to collect channel state data used for positioning, the second indication information indicates the terminal to send an uplink reference signal, and the uplink reference signal is used by the network side device to collect the channel state data used for positioning; and
the channel state data used for positioning comprises channel state data carrying a location label and channel state data not carrying a location label.

15. The data collection method according to claim 14, wherein the first indication information comprises at least one of the following:
a type identifier ID of data collection;
a target task of data collection;
a time interval of data collection;
a space interval of data collection;
an amount of data collection;
a start time of data collection;
an end time of data collection;
duration of data collection;
data accuracy of data collection;
a data accuracy requirement reported after the data collection;
format information reported after the data collection;
a data compression indication reported after the data collection;
downlink reference signal information for data collection;
a carrying indication of the location label;
a carrying indication of timestamp information;
a carrying indication of channel estimation error information;
a carrying indication of location labeling error information;
a carrying indication of reference signal measurement quality information;
a carrying indication of motion state information of the terminal; or
a data compression format.

16. The data collection method according to claim 14, wherein the second indication information comprises resource information for transmitting the uplink reference signal, and the resource information comprises at least one of the following:
port information, time domain information, frequency domain information, or space domain information.

17. The data collection method according to claim 14, wherein when the first information comprises the first indication information, the method further comprises:
receiving, by the network side device, the channel state data that is used for positioning and that is sent by the terminal.

18. The data collection method according to claim 17, wherein the channel state data received by the network side device comprises at least one of the following:
data that meets requirements of the first indication information;
a location label of the data;
channel estimation error information corresponding to the data;
location labeling error information corresponding to the data;
reference signal measurement quality information corresponding to the data;
motion state information of the terminal;
timestamp information of data collection;
a Transmission and Reception Point Identifier (TRP ID) corresponding to the data;
a cell identifier ID corresponding to the data;
third indication information or fourth indication information, wherein the third indication information represents that the data carries the location label, and the fourth indication information represents that the data does not carry the location label;
fifth indication information, wherein the fifth indication information indicates that data compression has been performed on the data; or
a format of the data compression.

19. The data collection method according to claim 17, further comprising:
receiving, by the network side device, first feedback information; and
determining, by the network side device based on the first feedback information, that the terminal has a first capability, wherein the first capability is a capability of providing the network side device with data conforming to the first indication information.

20. A terminal, comprising: a processor; and a memory having a computer program or an instruction stored thereon, wherein the computer program or the instruction, when executed by the processor, causes the processor to implement operations comprising:
receiving first information, wherein: the first information comprises first indication information or second indication information, the first indication information indicates the terminal to collect channel state data used for positioning, and the second indication information indicates the terminal to send an uplink reference signal;
when the first information comprises the first indication information, determining that the channel state data used for positioning needs to be collected; and
sending the uplink reference signal when the first information comprises the second indication information,
wherein:
the uplink reference signal is used by a network side device to collect the channel state data used for positioning, and
the channel state data used for positioning comprises channel state data carrying a location label and channel state data not carrying a location label.
